(19) United States
(12) Patent Application Publication
(10) Pub. No.: US 2022/0099469 A1
(43) Pub. Date: Mar. 31, 2022

(54) Physical Quantity Detection Device

(71) Applicant: Hitachi Astemo, Ltd., HItachinaka-shi, Ibaraki (JP)

(72) Inventors: Nozomi YATSUMONJI, Hitachinaka-shi (JP); Akira UENODAN, Hitachinaka-shi (JP); Takahiro MIKI, Hitachinaka-shi (JP); Hiroyuki ABE, Hitachinaka-shi (JP)

(21) Appl. No.: 17/416,585

(22) PCT Filed: Jan. 21, 2020
(86) PCT No.: PCT/JP2020/001811

§ 371 Date: Jun. 21, 2021

(30) Foreign Application Priority Data
Mar. 4, 2019 (JP) 2019-038892

(51) Int. Cl. G01F 1/684; G01F 15/14

(52) U.S. Cl. CPC G01F 1/6847; G01M 15/102; G01F 15/14; G01F 1/6842

(57) ABSTRACT

Provided is a physical quantity detection device capable of electrically connecting with a neutralization region arranged at a place through which a measurement target gas passes in a simple process. A physical quantity detection device 300 of the invention includes a housing 301 having a terminal 303 and a passage portion 100 through which a measurement target gas passes, and a support body 600 that supports a flow rate detection element 601. A neutralization region 500 is formed on the bottom surface of the passage portion of the housing, and the support body is supported by the housing such that the detection unit of the flow rate detection element faces the neutralization region.

### TECHNICAL FIELD

The invention relates to a physical quantity detection device for intake air of an internal combustion engine.

### BACKGROUND ART

PTL 1 discloses a structure of a physical quantity detection device in which a neutralization region is provided in a passage through which a measurement target gas flows to remove a charge of a contaminant as a countermeasure against contamination to avoid adhesion of contaminants to a flow rate detection unit.

### CITATION LIST

### Patent Literature

PTL 1: WO 2017/073271

### SUMMARY OF INVENTION

### Technical Problem

In the case of a structure in which a metal plate installed facing a flow rate detection element is connected to a circuit package as shown in PTL 1, a neutralization region needs to have a constant potential, and therefore needs to be connected to a GND of a circuit board or the like mounted on a housing side. Therefore, an electrical conduction structure in the thickness direction between the circuit board and the cover is required. An intermediate member having conductivity is required for the conduction structure, and the number of components increases. In addition, this is required to be performed in a process different from the process of electrical connection with the terminal necessary for connection with the external device, which leads to an increase in cost.

The invention has been made in view of the above points, and an object of the invention is to provide a physical quantity detection device capable of electrically connecting with a neutralization region arranged at a place through which a measurement target gas passes in a simple process.

### Solution to Problem

A physical quantity detection device of the invention includes a housing having a terminal and a passage portion through which a measurement target gas passes, and a support body that supports a flow rate detection element. A neutralization region is formed on a bottom surface of a passage portion of the housing, and the support body is supported by the housing such that a detection unit of the flow rate detection element faces the neutralization region.

### Advantageous Effects of Invention

According to the invention, a neutralization function can be realized in a simple process. In addition, since the cover can be excluded from the components of the passage, it is possible to reduce variations in passage dimensional tolerance of the flow rate detection element. Objects, configurations, and effects besides the above description will be apparent through the explanation on the following embodiments.

### BRIEF DESCRIPTION OF DRAWINGS

FIG. 1 is a front view of a physical quantity detection device.

FIG. 2 is a rear view of the physical quantity detection device.

FIG. 3 is a left side view of the physical quantity detection device.

FIG. 4 is a right side view of the physical quantity detection device.

FIG. 5 is a front view illustrating a state in which a cover is removed from the physical quantity detection device.

FIG. 6 is a cross-sectional view taken along line A-A of FIG. 1.

FIG. 7 is a front view illustrating another embodiment in which the cover is removed from the physical quantity detection device.

FIG. 8 is a cross-sectional view taken along line B-B of FIG. 7.

FIG. 9 is a cross-sectional view taken along line A-A illustrating another embodiment of the physical quantity detection device.

FIG. 10 is a cross-sectional view taken along line A-A illustrating another embodiment of the physical quantity detection device.

FIG. 11 is a cross-sectional view taken along line A-A illustrating another embodiment of the physical quantity detection device.

FIG. 12 is an enlarged view of a neutralization region in FIG. 5.

FIG. 13 is a cross-sectional view taken along line C-C of FIG. 4 illustrating another embodiment of the physical quantity detection device.

### DESCRIPTION OF EMBODIMENTS

### First Embodiment

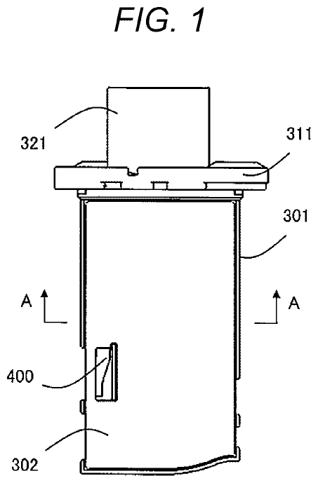

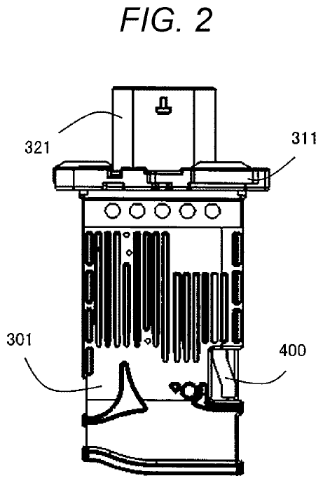

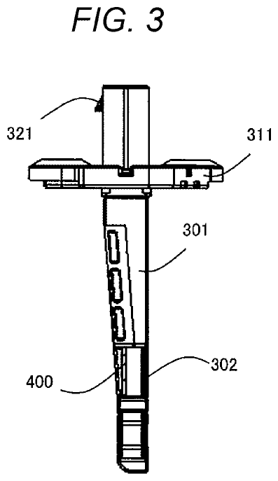

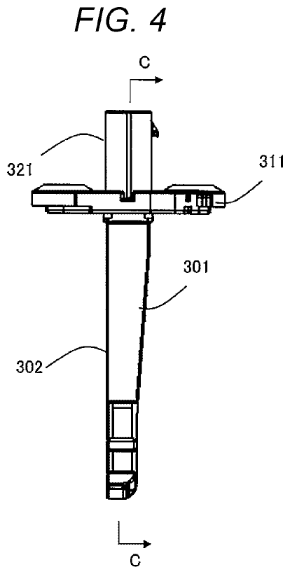

FIGS. 1 to 4 are diagrams illustrating an appearance of a physical quantity detection device 300. FIG. 1 is a front view of the physical quantity detection device 300, FIG. 2 is a rear view, FIG. 3 is a left side view, and FIG. 4 is a right side view.

The physical quantity detection device 300 includes a housing 301 and a cover 302. The housing 301 is formed by molding a synthetic resin material, and includes a flange 311 for fixing the physical quantity detection device 300 to the intake body, and an external connection portion 321 protruding from the flange 311 and having a connector for electrical connection with an external device.

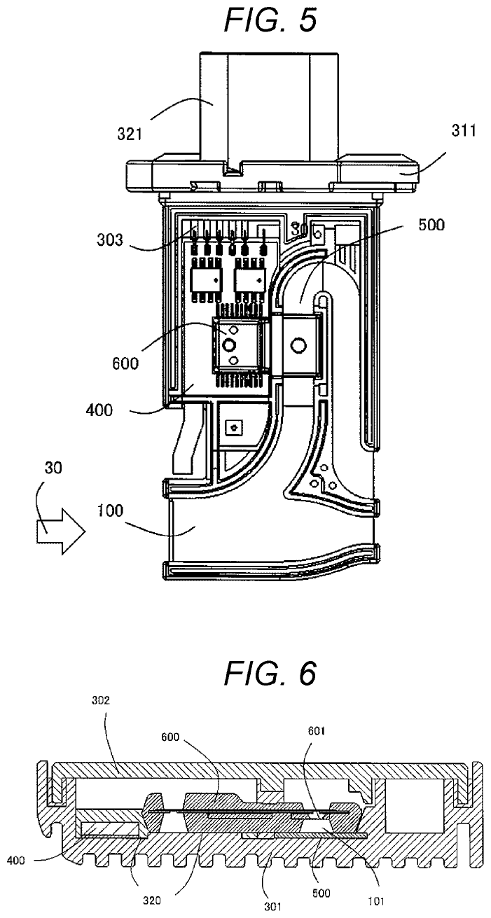

The housing 301 is provided with a circuit board 400 (see FIG. 5). The circuit board 400 is electrically connected to a detection element 601 supported by a support body 600. The detection element 601 is arranged in a passage 100 formed by the housing 301 and the cover 302, and a detection unit thereof is exposed to a measurement target gas 30 flowing through the passage 100. A part of the support body 600 is arranged in the sub-passage 100, and a part thereof is arranged in the circuit chamber.

The support body 600 may be a resin package sealed with resin so that at least the detection unit of the flow rate detection element 601 is exposed, or may be a resin molded body including a mounting portion on which the flow rate detection element 601 is mounted.

The housing 301 is provided with a neutralization region 500 having a function of eliminating static electricity of a contaminant flying together with the measurement target gas 30. The neutralization region 500 is provided from the passage 100 to the circuit chamber, and is electrically connected to the circuit board 400. The detection element 601 is supported by the support body 600 so as to face the neutralization region 500, and is installed in the housing 301 (see FIG. 6). The neutralization region 500 only needs to be grounded in terms of a circuit, is made of a conductive metal plate, a conductive resin, or the like, and is provided in the housing 301 by insertion, plating, or the like.

The support body 600 is arranged in contact with the housing 301 on the detection element 601 side, and the neutralization region 500 and the support body 600 constitute a detection passage portion 101.

According to this embodiment, by arranging the support body 600 that supports the detection element 601 in the housing so as to face the housing 301 side, the detection element 601 can face the neutralization region 500 formed in the housing 301 on which the circuit board 400 is mounted. A neutralization region can be formed in the housing 301, conduction from the circuit board 400 to the cover 302 is unnecessary, conduction in the mounting and stacking direction can be unnecessary, and a neutralization function can be provided on the detection element side in a simple process. Then, conduction between a terminal 303 provided in the housing 301 and the circuit board 400 and conduction between the neutralization region 500 and a constant potential of the circuit board 400 can be performed in the same process, and the process can be simplified.

In addition, by constituting the detection passage portion 101 of the detection element 601 by the housing 301, the cover 302 and the circuit board 400 can be excluded from the factors constituting the detection passage portion 101, and the dimensional variation of the detection passage portion 101 can be reduced and the detection accuracy can be improved as the tolerance of the cover 302 and the tolerance of the circuit board 400 can be ignored.

Further, by making the neutralization region 500 and the contact surface between the support body 600 and the housing 301 substantially flush, the dimensional tolerance of the housing can also be ignored from the height dimensional tolerance of the detection passage portion 101, so that the dimensional variation of the detection passage portion 101 can be reduced and the detection accuracy can be improved, which is more preferable.

### Second Embodiment

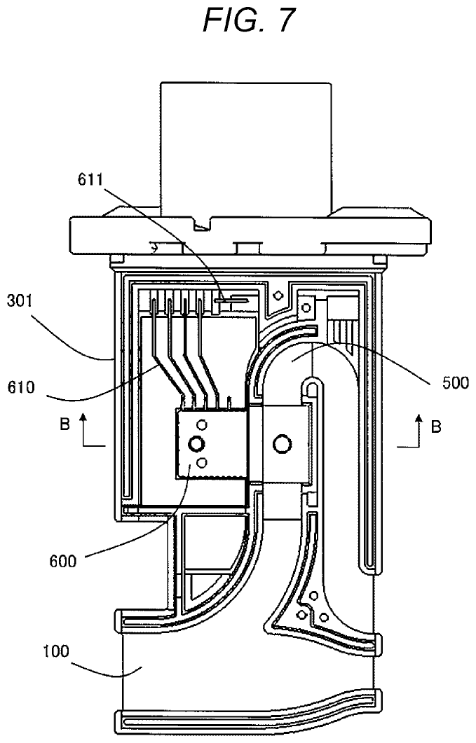

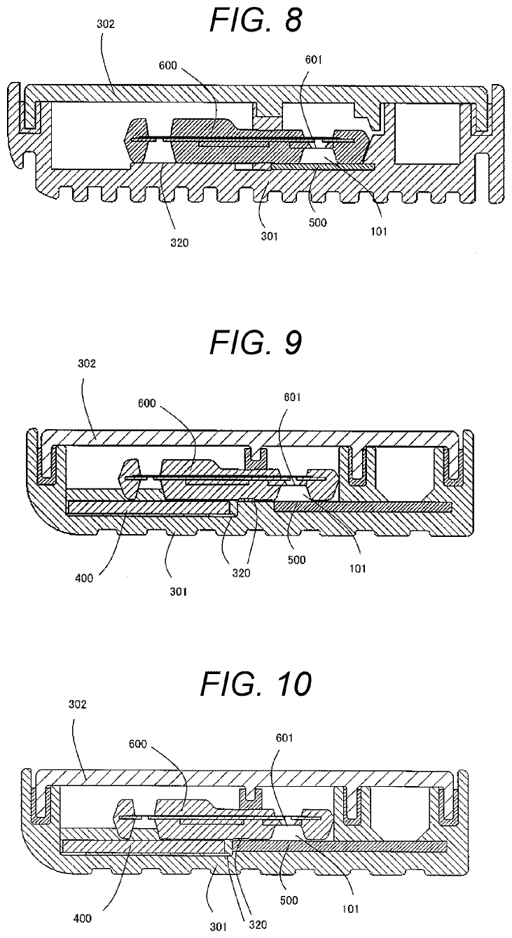

As illustrated in FIGS. 7 and 8, the support body 600 includes a lead frame 610 electrically connected to the terminal 303. The lead frame 610 is electrically connected to the terminal 303 by welding or the like. Further, the neutralization region 500 is electrically connected to the terminal 303 by welding or the like via a lead frame 611. In a case where a sensor such as a pressure sensor or a humidity sensor other than a sensor for measuring a flow rate is unnecessary, if a circuit function is provided in the support body 600, the circuit board 400 becomes unnecessary, and the number of components and cost can be reduced. Although not illustrated, the lead frame 610 may be connected to the neutralization region 500 and further connected to the terminal 303.

### Third Embodiment

As illustrated in FIG. 9, support body 600 is mounted on circuit board 400. After forming the circuit board assembly in which the support body 600 is mounted on the circuit board 400, the circuit board assembly is mounted on the housing 301. The support body 600 is mounted on the circuit board 400 such that the detection element side faces the back surface side of the circuit board 400.

In the housing 301, a step 320 is formed such that a mounting portion for mounting the circuit board 400 is outside a contact portion with which the support body 600 is in contact. When the circuit board 400 is mounted on the housing 301 after the support body 600 is mounted on the circuit board 400, the support body 600 can be brought into contact.

In addition, since the distance between the detection element 601 and the neutralization region 500 can be made shorter than the thickness of the circuit board 400 by providing the step 320 even without contact, it is possible to increase the flow velocity, and there is an effect that noise performance is improved even in a structure in which the neutralization region is provided on the housing side and the detection element is arranged to face the housing side.

When the detection element 601 side of the support body 600 is brought into contact with the housing 301, the height of the step 320 is more preferably larger than the distance from the bottom surface of the circuit board 400 to the contact portion in contact with the housing of the support body 600. Since variations in the circuit board 400 can be absorbed by the adhesive provided between the circuit board 400 and the housing 301, stress applied to the connection portion between the support body 600 and the circuit board 400 can be reduced.

### Fourth Embodiment

As illustrated in FIG. 10, the neutralization region may extend to the inner end of the step 320. In other words, the support body 600 is in contact with the housing 301 in the neutralization region 500. In a case where the neutralization region 500 is provided in the housing 301 by insertion or plating, a step is formed although it is minute. Even if such a step is included, the step is included in the range of substantially the same plane in the first embodiment, but since the contact portion and the portion forming the measurement passage 101 are formed in the same neutralization region, flatness is further improved.

### Fifth Embodiment

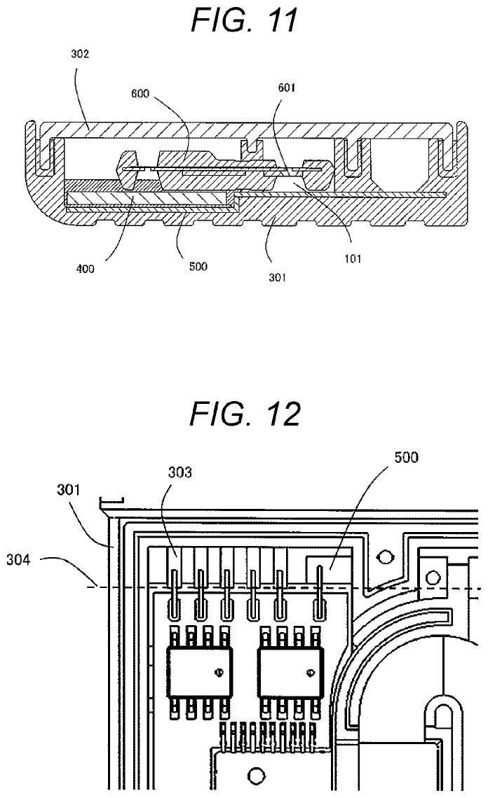

As illustrated in FIG. 11, the neutralization region 500 is installed up to the lower portion of the circuit board 400. Since the neutralization region 500 is formed of, for example, a metal plate, rigidity of the housing 301 can be improved, and vibration resistance is improved. In addition, since the metal plate is provided below the circuit board 400, an apparent linear expansion coefficient difference between the circuit board 400 and the housing 301 is reduced, deformation of the circuit board 400 can be reduced, and stress and strain of the electronic component mounted on the circuit board 400 can be reduced.

### Sixth Embodiment

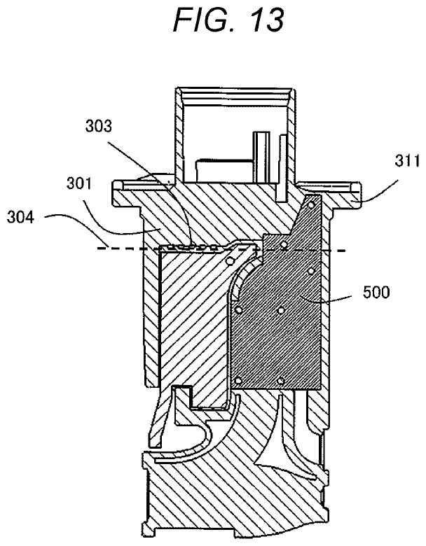

As illustrated in FIG. 12, the neutralization region 500 is installed in parallel with the terminal 303.

Further, the neutralization region 500 is installed on the base side (flange side) of the terminal 303 with respect to the terminal end surface 304. In this embodiment, since the neutralization region 500 is parallel to the terminal 303, workability of electrical connection can be improved. In addition, the neutralization region 500 is formed of, for example, a metal plate and is arranged on the base side of the terminal 303, so that the rigidity of the housing 301 is improved and the vibration resistance can be improved.

### Seventh Embodiment

As illustrated in FIG. 13, the neutralization region 500 is arranged on the base side of the terminal 303, and is further arranged up to the inside of the flange 311. The neutralization region 500 is formed of, for example, a metal plate and is arranged up to the inside of the flange, so that the rigidity of the housing 301 is improved and the vibration resistance can be improved.

Hitherto, the embodiments of the invention have been described, but the invention is not limited to the embodiments. Various modifications may be made within a scope not departing from the spirit of the invention disclosed in claims. For example, the above-described embodiments of the invention have been described in detail in a clearly understandable way, and are not necessarily limited to those having all the described configurations. In addition, some of the configurations of a certain embodiment may be replaced with the configurations of the other embodiments, and the configurations of the other embodiments may be added to the configurations of the subject embodiment. In addition, some of the configurations of each embodiment may be omitted, replaced with other configurations, and added to other configurations.

### REFERENCE SIGNS LIST

30 measurement target gas
100 passage portion
101 detection passage portion
300 physical quantity detection device
301 housing
302 cover
303 terminal
304 terminal end surface
311 flange
320 stepped portion
400 circuit board
500 neutralization region
600 support body
601 detection element
610, 611 lead frame

1. A physical quantity detection device, comprising:
a housing having a terminal and forming a part of the sub-passage; and
a support body configured to support a flow rate detection element,
wherein the housing has a neutralization region, and
the support body is arranged in the housing such that a detection unit of the flow rate detection element faces the neutralization region.

2. The physical quantity detection device according to claim 1, wherein the neutralization region is formed of a metal plate.

3. The physical quantity detection device according to claim 1, wherein the neutralization region is made of a conductive resin.

4. The physical quantity detection device according to claim 1, wherein the support body includes a lead frame, the lead frame is connected to the terminal, and the neutralization region is connected to the terminal.

5. The physical quantity detection device according to claim 1, wherein the support body includes a lead frame, the lead frame is connected to a circuit board, the neutralization region is connected to the circuit board, and the circuit board is connected to the terminal.

6. The physical quantity detection device according to claim 1, wherein, in the housing, a contact portion with the support body and a surface of the neutralization region are substantially flush.

7. The physical quantity detection device according to claim 1, wherein the neutralization region is provided in parallel with the terminal, and the neutralization region is arranged closer to a root side of the terminal than an end face of the terminal.

8. The physical quantity detection device according to claim 1, comprising
a circuit board on which the support body is mounted,
wherein the circuit board is mounted on a housing, and
the housing has a step where a mounting portion of the circuit board is located outside a contact portion with the support body.

9. The physical quantity detection device according to claim 8, wherein a height of the step is larger than a distance from a bottom surface of the circuit board to a contact portion in contact with a housing of the support body.

10. The physical quantity detection device according to claim 1, wherein the neutralization region is provided up to a lower portion of the circuit board.
